(19) United States
(12) Patent Application Publication
(10) Pub. No.: US 2011/0229798 A1
(43) Pub. Date: Sep. 22, 2011

(54) Connector for fuel cell and fuel cell system including the same

(76) Inventors: Hye-jung Cho, Anyang-si (KR); Young-seung Na, Yongin-si (KR); Suk-woong Kwon, Seoul (KR); Dae-yeon Soh, Hwaseong-si (KR); Yong-ki Kim, Seoul (KR)

(21) Appl. No.: 12/929,750

(22) Filed: Feb. 14, 2011

(30) Foreign Application Priority Data
Mar. 18, 2010 (KR) 10-2010-0024357

(51) Int. Cl. H01M 2/08

(52) U.S. Cl. 429/507

(57) ABSTRACT

A fuel cell system includes a fuel cell system connector and a fuel cartridge connector. The fuel cell system connector includes an external structure configured to accommodate a connector of a fuel cartridge and an internal structure mounted in the external structure. A contacting surface between the external structure and the internal structure of the fuel cell system connector includes a first nano-processed surface on a fuel supply path. The fuel cartridge connector includes an external structure having a retention key and an internal structure mounted in the external structure. A contacting surface between the external structure and the internal structure of the fuel cartridge connector includes a second nano-processed surface on a fuel supply path.

### BACKGROUND

1. Field

The present disclosure relates to fuel cells, and more particularly, to connectors for fuel cells and fuel cell systems including the connectors.

2. Description of the Related Art

A fuel cell system that directly uses a liquid fuel such as methanol includes a cartridge and a main body connected to the cartridge. Fuel to be used in power production is stored in the cartridge, and the fuel is supplied from the cartridge to the main body. The main body includes a power unit and other components. The power unit receives fuel from the cartridge and generates power by electro-chemical reaction. The other components support and control fuel supply and power production.

The main body and the cartridge may have a coupling structure that can be easily detached or attached.

Also, the above-described coupling structure may prevent leakage of fuel when the main body and the cartridge are coupled or uncoupled, that is, increase leakage stability, and may also increase coupling stability, and may prevent coupling of unauthorized cartridges, that is, increase manipulation stability.

The leakage stability needs to be maintained not only when the main body and the cartridge are coupled or uncoupled but also in an artificial leakage test such as a finger tip test.

When the manipulation stability is provided, other types of cartridges having a different fuel density from a regulated fuel density for a corresponding power unit and a different fuel storage method (e.g., a non-pressurized method or pressurized method) may be prevented from being coupled to the main body. Accordingly, as the manipulation stability is provided, fuels having not appropriate fuel densities or fuels supplied at abnormal speeds may be prevented from flowing into the power unit, thereby preventing degradation of the performance of the power unit and reduction in the reliability of the power unit.

If the coupling stability is high, the cartridge and the main body when coupled to each other are not released (uncoupled) due to movement of the fuel cell system or an impact applied to the fuel cell system while the fuel cell system is being used, but may be maintained stably coupled.

### SUMMARY

Embodiments are therefore directed to connector for a fuel cell and a fuel cell system including the connector, which substantially overcome one or more of the problems due to the limitations and disadvantages of the related art.

It is therefore a feature of an embodiment to provide connectors for fuel cells with which leakage stability, manipulation stability, and coupling stability may be provided when a main body and a cartridge of a fuel cell system are coupled to each other.

It is therefore another feature of an embodiment to provide fuel cartridges including the connectors and fuel cell systems.

Additional aspects will be set forth in part in the description which follows and, in part, will be apparent from the description, or may be learned by practice of the presented embodiments.

At least one of the above and other features and advantages may be realized by providing a fuel cell system connector that includes an external structure accommodating a connector of a fuel cartridge; and an internal structure mounted in the external structure, wherein a contact surface between the external structure and the internal structure comprises a nano-processed surface on a fuel supply path.

The internal structure may include a hanger that is extended over the external structure; and an elastic structure disposed in a vertical direction from the hanger, wherein the elastic structure provides a seal when the fuel cartridge is not coupled to the fuel cell system connector, and forms a fuel supply path while the fuel cartridge is coupled to the fuel cell system connector.

The external structure may include a first protrusion that surrounds a fuel inlet through which fuel supplied from the fuel cartridge flows, and accommodates a fuel outlet of the fuel cartridge; and a second protrusion that accommodates a circumferential portion of the fuel outlet in the connector of the fuel cartridge and surrounds the first protrusion, wherein an inner surface of the first protrusion has a nano-processed portion.

The elastic structure may include a rod that is disposed vertically from the hanger and divided into two portions; an elastic ring connecting the two portions of the rod; and an elastic body surrounding the portions of the rod inside the elastic ring, wherein a pin is formed at an end of an outer portion of the portions of the rod.

A selection key may be formed on an outer surface of the first protrusion, and a retention key may be formed on an inner surface of the second protrusion. The fuel inlet may be a cross-shaped hole.

At least one of the above and other features and advantages may also be realized by providing a fuel cartridge connector that includes an external structure including a retention key; and an internal structure mounted in the external structure, wherein a contacting surface between the external structure and the internal structure comprises a nano-processed surface on a fuel supply path.

The internal structure may include a hanger that is extended over the external structure; and an elastic structure that is formed in a vertical direction from the hanger, wherein the elastic structure provides a seal when the fuel cartridge connector is not coupled to an object that is to be supplied with fuel, and when the fuel cartridge connector is coupled to an object that is to be supplied with fuel, the elastic structure forms a fuel supply path.

The external structure may include a first protrusion that comprises a fuel outlet and is accommodated in a connector of an object that is to be supplied with fuel; and a second protrusion that is formed around a circumference of the first protrusion and comprises a groove and the retention key for accommodating a selection key accommodated in the object that is to be supplied with fuel, wherein an outer circumferential surface of the first protrusion comprises a nano-processed portion.

The elastic structure may include a rod that is formed in a vertical direction from the hanger, wherein the rod is divided into two portions; an elastic ring that connects two ends of the portions of the rod; and an elastic body that surrounds the portions of the rod inside the elastic ring.

The fuel outlet may be formed at a peak of the first protrusion, and be a cross-shaped hole.

At least one of the above and other features and advantages may also be realized by providing a fuel cell system including a fuel cartridge and a main body to which the fuel cartridge is coupled, that includes the main body comprises a first connector, and the fuel cartridge comprises a second connector coupled to the first connector, and the first connector is a fuel cell system connector according to an embodiment of the present invention, and the second connector is a fuel cartridge connector according to an embodiment of the present invention.

In the fuel cell system, a fuel inlet of the first connector and a fuel outlet of the second connector may be cross-shaped holes. An inner surface around a circumference of the fuel inlet of the first connector and an outer circumferential surface of the second connector contacting the inter surface may include nano-processed portions. One of the first and second connectors may include a selection key, and the other may include a space for accommodating the selection key.

The selection key may include two fixing keys and one auxiliary key.

The selection key may be located inward 4.6 mm (±0.01 mm) from an edge of the first protrusion of the external structure.

The fixing keys and the auxiliary key may be on the same plane.

A plurality of the auxiliary keys may be included.

At least one of the fixing keys and the auxiliary key may have a different shape from the others.

According to exemplary embodiments, fuel is supplied when the second connector of the fuel cartridge and the first connector of the main body are completely sealed. Also, the sealing between the first and second connectors is released after the fuel supply is completely shut. Accordingly, when detaching or attaching the cartridge from/to the main body, fuel leakage may be prevented.

Also, the arrangement of the fixing keys and the auxiliary key included in the first connector of the main body, particularly, the position of the auxiliary key, specifies a cartridge that may be coupled to the first connector. By using the auxiliary key as a selection key for selecting a predetermined cartridge, an inappropriate cartridge is prevented from being coupled to the first connector of the main body, thus increasing the manipulation stability.

Also, one of the first connector of the main body and the second connector of the cartridge may include a retention key, and the other may include a space for accommodating the retention key. By using the retention key, the main body and the cartridge may be maintained stably coupled, and thus the coupling stability may be increased.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a cross-sectional view illustrating a connector mounted to a main body of a fuel cell system that includes a power unit, according to an exemplary embodiment;

FIG. 2 illustrates a cross-sectional view illustrating a connector that is mounted to a fuel cartridge, according to an exemplary embodiment;

FIGS. 3 through 6 illustrate perspective views illustrating components included in the connector of FIG. 1;

FIG. 7 illustrates various alignment examples of selection keys installed in the connector of FIG. 1;

FIGS. 8 through 11 illustrate perspective views illustrating components included in the connector of FIG. 2;

FIG. 12 illustrates a cross-sectional view illustrating the connectors illustrated in FIGS. 1 and 2 being coupled to each other;

FIG. 13 illustrates a structural diagram illustrating a fuel cell system according to an exemplary embodiment;

FIG. 14 illustrates a graph showing fuel loss in a connector for a fuel cell due to evaporation over time according to an exemplary embodiment; and

FIG. 15 illustrates a bar graph showing fuel loss in a connector for a fuel cell due to evaporation over time according to an exemplary embodiment.

### DETAILED DESCRIPTION

Korean Patent Application No. 10-2010-0024357, filed on Mar. 18, 2010, in the Korean Intellectual Property Office, and entitled: “Connector for Fuel Cell and Fuel Cell System Including the Same,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

First, a connector for a fuel cell according to an embodiment of the present invention will be described hereinafter.

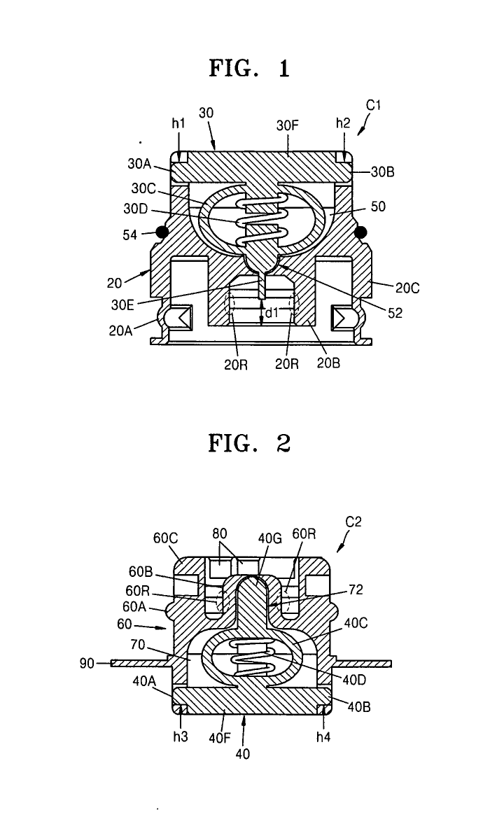

FIG. 1 illustrates a first connector C1 that is mounted to a main body of a fuel cell system that includes a power unit, according to an embodiment of the present invention.

Referring to FIG. 1, the first connector C1 includes a first external structure 20 and a first internal structure 30. The first internal structure 30 is formed in an inner portion of the first external structure 20. The first external structure 20 is formed of a material having resistance to corrosion that may occur due to fuel, e.g., methanol. For example, the first external structure 20 may be formed of ethylene, propylene, or ethylene propylene diene monomer (EPDM). The first internal structure 30 includes a hanger 30F and elastic structures 30C and 30D that are vertically formed from the hanger 30F. The hanger 30F includes external protrusions 30A and 30B formed on opposite sides of the hanger 30F. The first internal structure 30 is coupled to the first external structure 20 via the external protrusions 30A and 30B. In order to couple the first internal structure 30 to the first external structure 20, the first external structure 20 includes holes h1 and h2 respectively formed in positions corresponding to the external protrusions 30A and 30B, and the external protrusions 30A and 30B are inserted into the holes h1 and h2. The holes h1 and h2 and the hanger 30F are mounted in the main body of the fuel cell system.

The main body refers to all portions of the fuel cell system other than a fuel cartridge. The main body may include a power unit for generating power, components related to the power unit, a fuel supply system, a control unit, and the like. The main body may further include an auxiliary battery. The elastic structures 30C and 30D include a first elastic structure 30C and a second elastic structure 30D. The first elastic structure 30C is formed of an elastic material. In detail, the first elastic structure 30C may be an elastic geometrical structure having elasticity with respect to exterior force. For example, the first elastic structure 30C includes a rod, a first ring in the form of a half circle or a half oval that is formed on a first side of the rod, and a second ring on a second side of the rod in a configuration symmetrical to the first ring about the rod. A first end of the rod is connected to the hanger 30F. A pin 30E is formed at a second end of the rod opposite to the first end. The rod is divided into two portions. One of the portions of the rod is connected to the hanger 30F, and the pin 30E is formed at the other portion of the rod. Consequently, the two portions of the rod are connected via the first and second rings. A diameter of the rod may be, for example, 2.5 mm±0.01 mm. As will be described later, when a fuel cell cartridge is coupled to the first connector C1, fuel may flow into the connector along a surface of the rod. Accordingly, the rod functions as a fuel supply path. The second elastic structure 30D surrounds the two divided portions of the rod. The second elastic structure 30D maintains the elasticity of the first elastic structure 30C or may further increase the elasticity of the first elastic structure 30C. Due to the second elastic structure 30D, the first elastic structure 30C may quickly regain its original shape even after a long deformation. The second elastic structure 30C has resistance to corrosion that may occur due to fuel, and may be, for example, a SUS spring. The material of the first internal structure 30 other than the second elastic structure 30D may be the same as the first external structure 20. The second elastic structure 30D and the rod surrounded by the second elastic structure 30D may be both formed of SUS springs.

The first external structure 20 may have an internal structure in which the first internal structure 30 may be accommodated. The first external structure 20 has a first space 50 in which the first and second elastic structures 30C and 30D are accommodated. The first space 50 is connected to the holes h1 and h2. A second space 52 is concave and is formed in an inner surface of the first external structure 20 having the first space 50. The pin 30E of the rod of the first elastic structure 30C is accommodated in the second space 52. The pin 30E passes through a portion in which the second space 52 is formed. The portion through which the pin 30E passes has a shape for supplying fuel, which will be described later. When a fuel cartridge is coupled to the connector C1, the pin 30E is pushed backward due to force applied to the pin 30E. The pin 30E is formed as a single body with the rod, and thus when the pin 30E is pushed backward, the rod is also pushed backward. Accordingly, the rod around the pin 30E and the inner surface of the first external structure 20 in which the second space 52 is formed are separated from each other, thus being in a non-contact condition. Accordingly, fuel from the fuel cartridge may be supplied to the power unit through an open space between the rod around the pin 30E and the inner surface where the second space 52 is formed. While the fuel cartridge is not coupled to the connector C1, the rod around the pin 30E and the inner surface where the second space 52 is formed contact each other. A surface of the rod around the pin 30E and the inner surface where the second space 52 is formed are nano-processed.

In other words, a surface of a mold for forming the first connector C1 that corresponds to the rod around the pin 30E and a surface of the mold that corresponds to a portion where the second space 52 is to be formed are processed by using a super high glossy process (all-round mirror face processing).

When a product (e.g., a fuel connector according an embodiment of the present invention) is manufactured using an injection mold having a portion that is processed by using a super high glossy process (all-round mirror face processing), a surface of the product corresponding to the super high glossy processed portion of the injection mold is referred to as being nano-processed. The nano-processed surface may have minimized surface deviations, and thus the nano-processing portion may have an excellent sealing property.

The nano-processing may be, for example, 10 nano-processing or 20 nano-processing. Surface roughness of a surface of the rod around the nano-processed pin 30E and the inner surface where the second space 52 is formed is far smaller than other portions. For example, the surface roughness thereof may be about 20 nm to about 30 nm.

As described above, since the surface of the rod around the pin 30E and the inner surface where the second space 52 is formed are nano-processed, when the surface of the rod around the pin 30E and the inner surface where the second space 52 is formed contact each other, there is no gap along which fuel might flow between the rod and the inner surface where the second space 52 is formed. Accordingly, fuel in the first space 50 of the first external structure 20 may be prevented from leaking out of the first connector C1 when a fuel cartridge is not coupled to, e.g., disconnected from, the first connector C1.

In addition, the first external structure 20 includes a first protrusion 20B and a second protrusion 20C that are axis-symmetrical with respect to the second space 52. The first and second protrusions 20B and 20C are separated from each other. The first and second protrusions 20B and 20C are concentric around the second space 52, that is, around the pin 30E. The first and second protrusions 20B and 20C may be cylindrical or may have any of other shapes. For example, the first and second protrusions 20B and 20C may be quadrilateral or oval-cylindrical, or may have cross-sections other than circular cross-sections and oval-shaped cross-sections. The second protrusion 20C may protrude longer than the first protrusion 20B with respect to the pin 30E. An inner diameter of the first protrusion 20B may be about 7 mm or less, for example, 4.8 mm±0.01 mm. An outer diameter of the first protrusion 20B may be about 10 mm or less, for example, 7.4 mm±0.01 mm. A vertical distance between a protruded end of the first protrusion 20B and the pin 30E may be about 4 mm or less, for example, 3.1 mm±0.05 mm. Although not shown in FIG. 1, a first selection key is formed on a circumferential surface of the first protrusion 20B. A second selection key that corresponds to the first selection key is formed on a second connector C2 illustrated in FIG. 2. The second selection key is a space for accommodating the first selection key, but will be referred to as the second selection key for convenience. The functions of the first and second selection keys may be exchanged. That is, the second selection key may be the actual selection key, and the first selection key may be a space for accommodating the second selection key.

Accordingly, as the first and second connectors C1 and C2 are coupled via corresponding selection keys thereof, inappropriate fuel cartridge may be prevented from being coupled to the first connector C1. A groove 20A is formed in an inner surface of the second protrusion 20C and an external surface corresponding to where the groove 20a is formed may be convex. However, if a thickness of the second protrusion 20C is sufficient to accommodate a depth of the groove 20A, the external surface where the groove 20A is formed may not be convex. A unit for coupling and maintenance, that is, a retention key, is formed in a fuel cartridge, and may be inserted into the groove 20A. An inner diameter of the second protrusion 20C may be about 16 mm or less, for example, 13.0 mm±0.02 mm. The first and second protrusions 20B and 20C are exposed out of the power unit. An O-ring 54 and a groove in which the O-ring 54 may be located are formed on the first external structure 20 between the first holes h1 and h2 and the first and second protrusions 20B and 20C. The O-ring 54 is used for a more complete sealing between the power unit and the first connector C1 when mechanically coupling the first connector C1 to the power unit.

FIG. 2 is a cross-sectional view illustrating the second connector C2, which is mounted to a fuel cartridge, according to an embodiment of the present invention.

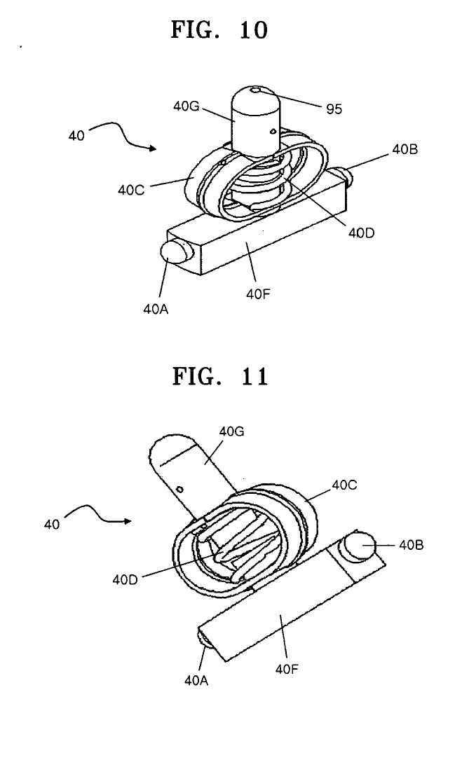

Referring to FIG. 2, the second connector C2 includes a second external structure 60 and a second internal structure 40. The second external structure 60 may be formed of the same material as the first external structure 20 of the first connector C1. The second internal structure 40 is formed inside the second external structure 60. The second internal structure 40 includes a hanger 40F and elastic structures 40C and 40D that are vertically formed from the hanger 40F. The hanger 40F includes two protrusions 40A and 40B at two ends thereof. The second internal structure 40 is coupled to the second external structure 60 via the protrusions 40A and 40B. To this end, the second external structure 60 has holes h3 and h4 respectively formed in positions corresponding to the protrusions 40A and 40B, and the protrusions 40A and 40B are inserted into the holes h3 and h4. The holes h3 and h4 and the hanger 40F are disposed inside the fuel cartridge. Fuel of the fuel cartridge is supplied through two side portions of the hanger 40F between the protrusions 40A and 40B. The elastic structures 40C and 40D include a third elastic structure 40C and a fourth elastic structure 40D. The third elastic structure 40C is formed of an elastic material and may be an elastic geometrical structure. For example, the third elastic structure 40C includes a rod 40G, a third ring in the form of a half circle or. a half oval and formed on a first side of the rod 40G, and a fourth ring on a second side of the rod 40G in a configuration symmetrical to the third ring about the rod. The third elastic structure 40C may be the same as the first elastic structure 30C of the first connector C1. A first end of the rod 40G is connected to the hanger 40F. A shallow groove 95 is formed at a second end of the rod 400 opposite to the first end, that is, at a peak point of the rod 40G, as illustrated in FIG. 10. When the first and second connectors C1 and C2 are coupled to each other, the pin 30E of the first connector C1 is inserted into the groove 95. The rod 400 is divided into two portions. One of the two portions of the rod 400 is connected to the hanger 40F, and the other portion contacts the pin 30E when the first and second connectors C1 and C2 are coupled to each other. The two portions of the rod 400 are connected to each other via the third and fourth rings. A diameter of the rod 400 may be, for example, 2.5 mm±0.01 mm. When the first and second connectors C1 and C2 are coupled to each other, the fuel of the fuel cartridge may flow into the first connector C1 along the surface of the rod 40G. Accordingly, the rod of the first connector C1 and the rod 400 of the second connector C2 may form a fuel supply path between the fuel cartridge and the main body.

The fourth elastic structure 40D surrounds a portion of the two portions of the rod 40G. That is, the fourth elastic structure 40D surrounds inner portions of the third and fourth rings of the rod 40G. The second elastic structure 30D of the first connector C1 also surrounds inner portions of the first and second rings of the rod in the same shape as the fourth elastic structure 40D.

The fourth elastic structure 40D maintains the elasticity of the third elastic structure 40C or may further increase elasticity of the third elastic structure 40C (see above). Due to the fourth elastic structure 40D, the third elastic structure 40C may quickly regain its original shape even after a long deformation. The fourth elastic structure 40D has resistance to corrosion that may be occur due to fuel, and may be, for example, a SUS spring. All of portions of the second internal structure 40 other than the fourth elastic structure 40C are formed of the same material as the external structure 60.

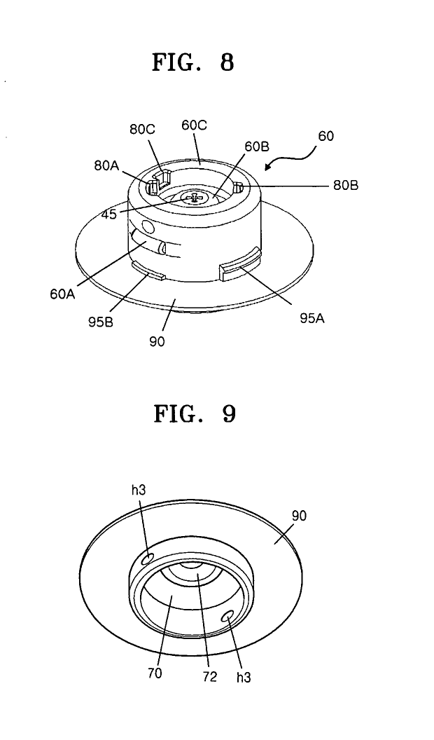

The second external structure 60 has an internal structure in which the second internal structure 40 may be accommodated. The second external structure 60 has a third space 70 in which the elastic structures 40C and 40D may be accommodated. The third space 70 is connected to the holes h3 and h4. A concave fourth space 72 is formed in an inner surface of the second external structure 60 having the third space 70. The fourth space 72 contacts an upper portion of the rod 40G, that is, where portion of the rod 40G above the third and fourth rings is accommodated in the fourth space 72. A hole through which fuel passes is formed in a portion of the inner surface where the fourth space 72 is formed and that corresponds to the peak point of the rod 40G. The hole may be cross-shaped as illustrated in FIG. 8.

When the fuel cartridge is coupled to the power unit, the rod 40G is pushed backward due to the pin 30E of the first connector C1. Accordingly, the rod 40G and the inner surface of the second external structure 60 where the fourth space 72 is formed are separated from each other, thus being in a non-contact condition. Accordingly, an open path is formed between the rod 40G and the inner surface of the second external structure 60 where the fourth space 72 is formed, and the fuel of the fuel cartridge may be supplied through the open path and the first connector C1 to the power unit. While the fuel cartridge is not coupled to the power unit, a surface around the peak point of the rod 400 and the inner surface of the second external structure 60 where the fourth space 72 is formed contact each other.

The surface around the peak point of the rod 40G and the inner surface of the second external structure 60 where the fourth space 72 is formed are nano-processed. In other words, the surface around the peak point of the rod 40G and the inner surface of the second external structure 60 where the fourth space 72 is formed are nano-processed during a molding process for forming the second connector C2. The nano-processing may be, for example, 10 nano-processing or 20 nano-processing. By forming the second connector C2 using a mold having a nano-processed portion, surface roughness of the surface around the peak point of the rod 40G and the inner surface of the second external structure 60 where the fourth space 72 is formed is far smaller than other portions. Accordingly, when the rod 400 and the inner surface of the second external structure 60 where the fourth space 72 is formed contact each other, there is no gap at all through which fuel may flow between the rod 400 and the inner surface of the fourth space 72. Accordingly, fuel in the third space 70 of the second external structure 60 may be prevented from leaking out of the second connector C2 while the fuel cartridge is not coupled to the power unit.

The second external structure 60 includes third and fourth protrusions 60B and 60C. The third and fourth protrusions 60B and 60C are separated from each other. When the second connector C2 is mounted to the fuel cartridge, the third and fourth protrusions 60B and 60C are exposed out of the fuel cartridge, and a remaining portion of the second connector C2 is disposed inside the fuel cartridge. The third and fourth protrusions 60B and 60C are formed as concentric circles around the fourth space 72, that is, the rod 40G. The third and fourth protrusions 60B and 60C may be cylindrical or have any of other shapes. For example, the third and fourth protrusions 60B and 60C may be quadrilateral or oval-cylindrical, or may have cross-sections other than circular cross-sections and oval-shaped cross-sections. Since the second connector C2 is coupled to the first connector C1, the shapes of the third and fourth protrusions 60B and 60C of the second connector C2 may correspond to those of the first and second protrusions 20B and 20C of the first connector C1. A length of the third protrusion 60B may be shorter than a length of the fourth protrusion 60C. The third protrusion 60B is inserted into an inner portion of the first protrusion 20B of the first connector C1. The fourth protrusion 60C is inserted between the first and second protrusions 20B and 20C of the first connector C1. In other words, the first protrusion 20B of the first connector C1 is inserted between the third and fourth protrusions 60B and 60C. Accordingly, a length of the third protrusion 60B may be the same as an inner length of the first protrusion 20B. A predetermined area 60R of an outer circumferential surface of the third protrusion 60B is nano-processed. The nano-processing refers to a nano-processing obtained using a mold as described above. The precision of the nano-processing may be as described above. An area 20R of the inner surface of the first protrusion 20B of the first connector C1, contacting the nano-processed area of the outer circumferential surface of the third protrusion 60B is nano-processed using a mold. Accordingly, when the first and second connectors C1 and C2 are coupled to each other, there is no gap along which fuel might flow between the nano-processed inner surface of the first protrusion 20B and the nano-processed circumferential surface of the third protrusion 60B. Accordingly, it may be prevented that fuel, which may be in the first space 50 of the first external structure 20, leaks out of the first connector C1 while the fuel cartridge is not coupled to the power unit.

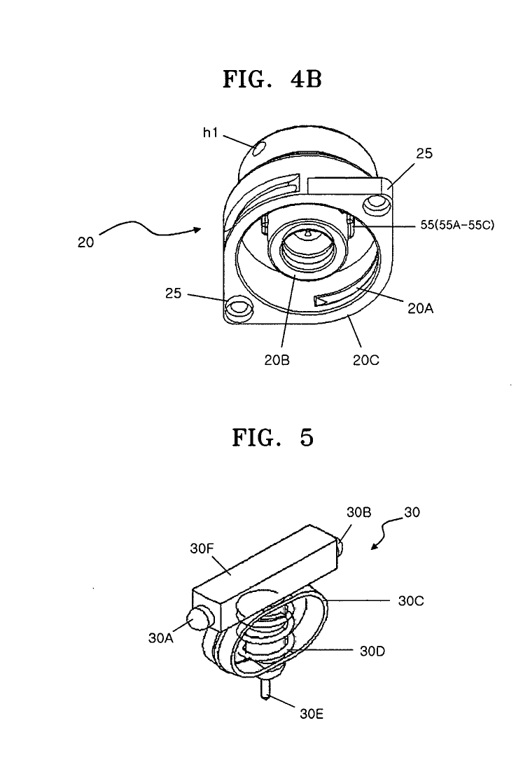

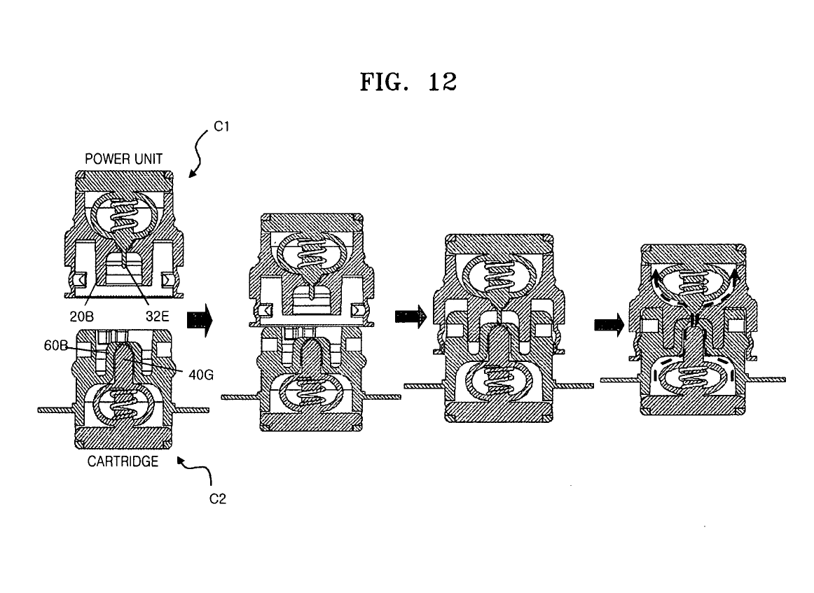

The fourth space 72 is formed in an inner portion of the third protrusion 60B of the second external structure 60. Accordingly, when the fuel cartridge and the power unit are not coupled, the rod 40G is surrounded by the third protrusion 60B. A second selection key 80 is included in an inner surface of the fourth protrusion 60C. When the first and second connectors C1 and C2 are coupled to each other, the first selection key 80 and a first selection key 55 (see FIGS. 4A and 4B) of the first connector C1 are coupled first substantially, and thus the second selection key 80 may be formed in an inner surface of an outer end of the second protrusion 60C. The second selection key 80 corresponds to the first selection key 55 formed in the first protrusion 20B of the first connector C1. Accordingly, when the first and second connectors C1 and C2 are coupled to each other, the first selection key 55 is inserted into the second selection key 80. The properties of the first and second selection keys 55 and 80 may be exchanged. That is, the second selection key 80 may be formed in the first connector C1, and the first selection key 55 may be formed in the second connector C2. Like the first selection key 55, the second selection key 80 may have any of various combinations. A convex portion 60A is formed along an outer circumference of the fourth protrusion 60C. The convex portion 60A is used for coupling and maintenance, and may be, for example, a retention key. When the first and second connectors C1 and C2 are coupled, the convex portion 60A of the fourth protrusion 60C is inserted into the groove 20A formed in the inner surface of the second protrusion 20C of the first connector C1, which is a space for accommodating the retention key. As shown in FIG. 12 where the first and second connectors C1 and C2 are being coupled, the convex portion 60A of the second connector C2 may be located in such a position as to be inserted into the groove 20A of the first connector C1 at the same time when the first protrusion 20B of the first connector C1 and the third protrusion 60B of the second connector C2 are sealed by being coupled or right after they are sealed. The sealing process means that the nano-processed portion 20R of the inner surface of the first protrusion 20B of the first connector C1 and the nano-processed portion 60R of the outer circumferential surface of the third protrusion 60B of the second connector C2 are contacted to be coupled. The convex portion 60A of the fourth protrusion 60C may be disposed lower than the second selection key 80 and higher than the third space 70. A circular plate 90 is formed between the holes h3 and h4 of the second external structure 60 and the convex portion 60A along the outer circumferential surface of the second external structure 60. The circular plate 90 has a predetermined width, starting from the outer circumferential surface of the second external structure 60. The circular plate 90 is attached to an inner surface of the fuel cartridge. Accordingly, a portion of the second connector C2 that is lower than the circular plate 90 is located inside the fuel cartridge.

Meanwhile, sizes of elements of the first and second connectors C1 and C2 illustrated in FIGS. 1 and 2 denote diameters, heights, or lengths of portions of the elements, but are not limited thereto.

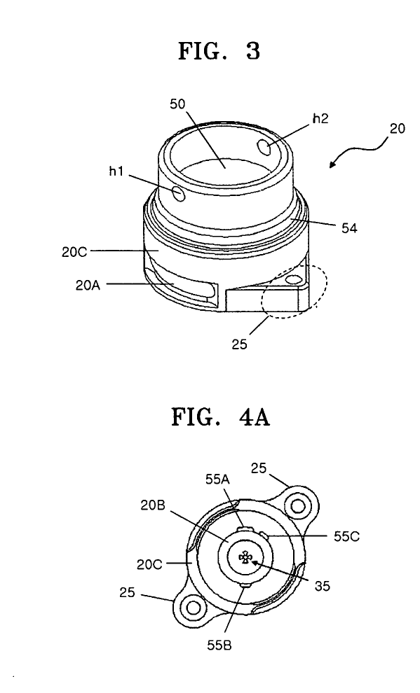

FIGS. 3, 4A, and 4B illustrate the first external structure 20 of the first connector C1 illustrated in FIG. 1 in various directions. Referring to FIGS. 3, 4A and 4B, the elements of the first external structure 20 are each clearly illustrated. Referring to FIG. 3, a coupling portion 25 is used to couple the first connector C1 to the power unit. The first connector C1 may be, for example, screw-coupled to the power unit via the coupling portion 25.

FIG. 4A is a front view of the first external structure 20. Referring to FIG. 4A, a hole 35 through which fuel and the pin 30E may pass during coupling is formed. The hole 35 is cross-shaped, and the pin 30E passes through a center portion of the hole 35. Fuel passes through portions of the hole 35 other than the portion through which the pin 30E passes.

Referring to FIG. 4A, first selection keys 55A through 55C are formed on an outer circumferential surface of the first protrusion 20B. The first selection keys 55A through 55C may include a first fixing key 55A, a second fixing key 55B that is fixed with respect to the first fixing key 55A, and an auxiliary key 55C positioned between the first and second fixing keys 55A and 55B. The first and second fixing keys 55A and 55B and the auxiliary key 55C may be on the same plane. The first fixing key 55A and the second fixing key 55B may be on opposite sides to each other. A plurality of the auxiliary keys 55C may be disposed between the first and second fixing keys 55A and 55B. At least one of the first and second fixing keys 55A and 55B and the auxiliary key 55C may have a different shape from the rest. A height of the auxiliary key 55C may be about 3.0 mm or less, for example, 1.5 mm±0.01 mm. A thickness of the auxiliary key 55C measured from the outer circumferential surface of the first protrusion 20B may be about 2 mm or less, for example, 0.5 mm±0.01 mm. The height and thickness of the first and second fixing keys 55A and 55B may be the same as that of the auxiliary 55C. A distance between an outer end of the first protrusion 20B and the first and second fixing keys 55A and 55B and the auxiliary key 55C may be about 6 mm or less, for example, 4.6 mm±0.01 mm.

Referring to FIG. 4B, a position of the first selection key 55 and a position and shape of the groove 20A of the second protrusion 20C are illustrated. The groove 20A is formed having a predetermined length along the circumference of the second protrusion 20C. Two grooves 20A are formed in the second protrusion 20C, facing each other. Two or more grooves may be formed in the second protrusion 20C as retention keys.

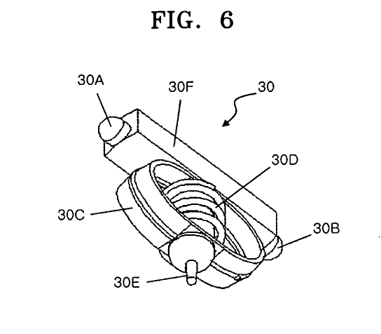

FIGS. 5 and 6 are perspective views illustrating the first internal structure 30 illustrated in FIG. 1 from two directions, respectively.

Referring to FIGS. 5 and 6, the connection between the first and second elastic structures 30C and 30D, the hanger 30F, and the pin 30E and the shape thereof are clearly illustrated.

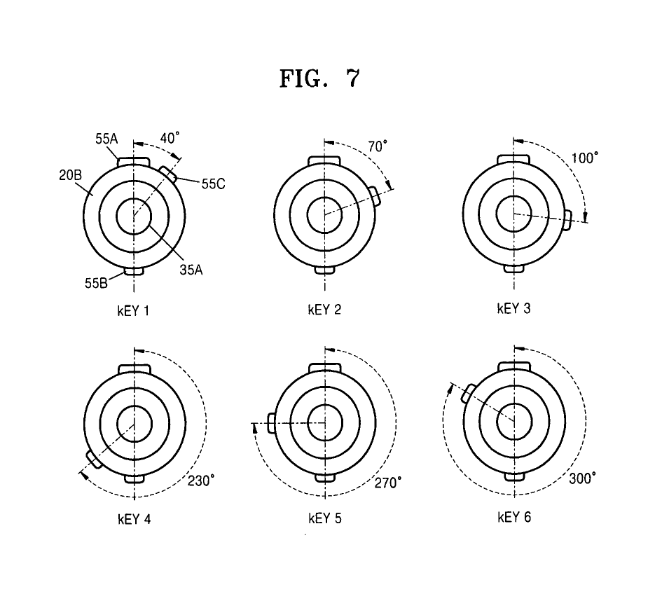

FIG. 7 illustrates various alignment examples of the first selection keys 55A through 55C. A portion 35A in FIG. 7 is an area where the hole 35 is formed. The hole 35 is not illustrated in FIG. 7 for convenience. The first and second fixing keys 55A and 55B are opposite to each other, and positions thereof are fixed.

Referring to FIG. 7, in an example Key 1, the auxiliary key 55C is formed on a circumferential surface of the first protrusion 20B at a position rotated at 40 degrees with respect to a line that connects the first and second fixing keys 55A and 55B around the area 35A. In an example Key 2, the auxiliary key 55C is formed on a circumferential surface of the first protrusion 20B at a position rotated 70 degrees with respect to the line that connects the first and second fixing keys 55A and 55B around the area 35A. In examples Key 3, Key 4, Key 5, and Key 6, the auxiliary key 55C is formed on a circumferential surface of the first protrusion 20B at positions rotated 100, 230, 270, and 300 degrees, respectively.

In order for the first connector C1 and the second connector C2 to be accurately coupled, the first and second fixing keys 55A and 55B and the auxiliary key 55C formed on the outer circumferential surface of the first protrusion 20B of the first connector C1 need to be exactly matched with the second selection key 80, that is, grooves of the fourth protrusion 60C of the second connector C2. The first and second fixing keys 55A and 55B and the auxiliary key 55C are inserted into the grooves, respectively.

Accordingly, when the first and second fixing keys 55A and 55B and the auxiliary key 55C are aligned as in the example Key 1 of FIG. 7, a groove formed in the inner surface of the second protrusion 60C of the second connector C2, which is formed to accommodate the auxiliary key 55C, needs to be formed in a position corresponding to the auxiliary key 55C so that the fuel cartridge and the power unit are exactly coupled.

While the first and second fixing keys 55A and 55B are fixed, the type of the fuel cartridge to be coupled to the power unit may be determined according to the position of the auxiliary key 55C. Accordingly, when a predetermined cartridge is designated according to the position of the auxiliary key 55C, that is, according to the alignment of the first and second fixing keys 55A and 55B and the auxiliary key 55C as a whole, the auxiliary key 55C may be used as an authentication key for authenticating whether a cartridge is allowed to be coupled to the power unit.

For example, when the auxiliary key 55C and the first fixing key 55A are aligned as in the example Key 1 of FIG. 7, the auxiliary key 55C may be a key that authenticates a non-pressurized cartridge having a fuel concentration of 98±1.5 mass %, hereinafter referred to as a first cartridge. If the first cartridge has a second selection key that can accurately accommodate the first and second fixing keys 55A and 55B and the auxiliary key 55C aligned as in the example Key 1 of FIG. 7, the first cartridge may be coupled to the power unit normally.

In the same manner, the auxiliary key 55C at an angle of 70 degree to the first fixing key 55A as in the example Key 2 of FIG. 7, may be, for example, a key for authenticating a non-pressurized cartridge, hereinafter referred to as a second cartridge, having a fuel concentration of 64.0±1.5 mass %. Also, in the case of the example Key 3 of FIG. 7, the auxiliary key 55C may be, for example, a non-pressurized cartridge, hereinafter referred to as a third cartridge, having a fuel concentration of 61.8±1.5 mass %. Also, in the case of the example Key 4 of FIG. 7, the auxiliary key 55C may be, for example, a pressurized cartridge, hereinafter referred to as a fourth cartridge, having a fuel concentration of 98±1.5 mass %. Also, in the case of the example Key 5 of FIG. 7, the auxiliary key 55C may be, for example, a pressurized cartridge, hereinafter referred to as a fifth cartridge, having a fuel concentration of 64.0±1.5 mass %. Also, in the case of the example Key 6 of FIG. 7, the auxiliary key 55C may be, for example, a pressurized cartridge, hereinafter referred to as a sixth cartridge, having a fuel concentration of 61.8±1.5 mass %.

In FIG. 7, a width of the first fixing key 55A may be about 4.0 mm or less, for example, 2.2 mm (±0.01 mm). Also, a width of the second fixing key 55B may be about 2.5 mm or less, for example, 1.4 mm (±0.01 mm). Also, a width of the auxiliary key 55C may be about 2 mm or less, for example, 1.4 mm (±0.01 mm).

FIGS. 8 and 9 illustrate the second external structure 60 of the second connector C2 illustrated in FIG. 2 in various directions.

Referring to FIG. 8, the third protrusion 60B is formed in an inner region of the fourth protrusion 60C. The fourth protrusion 60C is higher than the third protrusion 60B. Unlike the fourth protrusion 60C, the third protrusion 60B is closed. However, a cross-shaped hole 45 is formed in a top portion of the third protrusion 60B. As illustrated in FIG. 2, the peak point of the rod 40G is disposed right below the cross-shaped hole 45. Horizontal and vertical lengths of the cross-shaped hole 45, that is, a width of a portion through which fuel substantially flows, may be smaller than 1 mm. Also, a center portion of the hole 45, that is, a diameter of the hole 45 into which the pin 30E of the first connector C1 is to be inserted, may also be 1 mm or smaller. Consequently, the second connector C2 is not opened even when performing a finger tip test to test whether fuel leaks by using a test rod having a diameter of 1 mm and a length of 200 mm, thereby preventing leakage of fuel.

Furthermore, first through third grooves 80A through 80C are formed inside an opening of the fourth protrusion 60C. The first through third grooves 80A through 80C correspond to the second selection key 80 described with reference to FIG. 2. When the first and second connectors C1 and C2 are coupled, the first and second fixing keys 55A and 55B formed on the outer surface of the first protrusion 20B of the first connector C1 are inserted into the first and second grooves 80A and 80B, and the auxiliary key 55C is inserted into the third groove 80C. Coupling keys 95A and 95B that are separated from each other are formed on the outer circumferential surface of the second external structure 60 above the circular plate 90. The coupling keys 95A and 90B are extended to a predetermined length along the outer circumferential surface of the second external structure 60. The coupling keys 95A and 95B contact the circular plate 90. Measured from the circular plate 90, the first coupling key 95A is longer than the second coupling key 95B. The retention key 60A is located above the second coupling key 95B on the outer circumferential surface of the second external structure 60. The second coupling key 95B and the retention key 60A are both arranged along a line that is parallel to the outer circumferential surface or may not be arranged along the line that is parallel to the outer circumferential surface. The coupling keys 95A and 95B are used to mount the second connector C2 to the fuel cartridge. When the second connector C2 is mounted to the fuel cartridge, a boundary of an opening of the fuel cartridge to which the second connector C2 is mounted is disposed between the first coupling key 95A and the second coupling key 95B. An inner surface of the opening of the fuel cartridge is attached to the surface of the circular plate 90. To this end, an adhesive may be attached to the surface of the circular plate 90.

Referring to FIG. 9, the third space 70 and the fourth space 72 in which the second internal structure 40 of FIG. 2 is located are illustrated.

FIGS. 10 and 11 illustrate the second internal structure 40 in various directions.

Referring to FIGS. 10 and 11, the shape of the second internal structure 40 is clearly illustrated, and the detailed shape of the hanger 40F, the protrusions 40A and 40B, and the first and second elastic structures 40C and 40D, and their connections, are clearly illustrated.

Referring to FIG. 10, the shallow groove 95 is formed at the peak point of the rod 40G. The peak point of the rod 40G corresponds to the center portion of the cross-shaped hole 45.

FIG. 12 illustrates a coupling process in which the first and second connectors C1 and C2 are coupled to each other, sequentially in an order, from left to right.

Referring to FIG. 12, the nano-processed portion of the inner surface of the first protrusion 20B of the first connector C1 and the nano-processed portion of the outer circumferential surface of the third protrusion 60B of the second connector C2 contact each other to be sealed (a third drawing from the left), and then the first and second connectors C1 and C2 are coupled to each other and maintained using a retention key, and a pin 32E of the first connector C1 is inserted into the groove 95 formed at the peak point of the rod 40G of the second connector C2. After the pin 32E of the first connector C1 is inserted into the groove 95 formed at the peak point of the rod 40G of the second connector C2, the pin 32E of the first connector C1 is pushed backward and then the rod 40G of the second connector C2 is also pushed backward. As a result, as shown with a dotted line in a rightmost drawing, fuel is supplied from the second connector C2 to the first connector C1. Fuel flows through the horizontal and vertical portions of the cross-shaped hole 45 formed at the peak point of the third protrusion 60B of the second connector C2 and horizontal and vertical portions of the cross-shaped hole 35 formed on a bottom of the inner portion of the first protrusion 20B of the first connector C1.

As shown in the rightmost drawing of FIG. 12, after the first and second connectors C1 and C2 are coupled, and if an amount of fuel per minute, supplied from the fuel cartridge to a body to which the fuel cartridge is to be mounted, for example, the main body of the fuel cell system, is 30 cc, a fuel supply pressure may be, for example, 20 kPa or less.

The sealing condition of the first and second connectors C1 and C2 and the fuel supply pressure thereof according to the amount of fuel supplied per minute may be greater or smaller than 20 kPa.

FIG. 13 illustrates a fuel cell system S according to an embodiment of the present invention.

Referring to FIG. 13, the fuel cell system S includes a main body 100 including a power unit, a control circuit unit, a fuel supply device, a DC-DC converter, an auxiliary battery, and a fuel cartridge 200 in which fuel is stored. The main body 100 receives fuel from the fuel cartridge 200. The fuel has a predetermined concentration. The fuel may be, for example, methanol. The cartridge 200 may be a pressurizing type, including a pressurizing unit for pressurizing a fuel pack in which fuel is stored, or may be a non-pressurizing type which does not include a pressurizing unit. The main body 100 includes a first coupling portion 110, and the cartridge 200 includes a second coupling portion 210. The main body 100 and the cartridge 200 are coupled to each other via the first and second coupling portions 110 and 210. The first coupling portion 110 may also not protrude from the main body 100. For example, a groove may be formed in the main body 100 for the first coupling portion 110, and the first coupling portion 110 may be mounted in the groove. A portion of the first coupling portion 110 exposed out of the first coupling portion 110 may be smaller than or the same as a depth of the groove. For example, the first coupling portion 110 may be the first connector C1. Also, the second coupling portion 210 may be, for example, the second connector C2.

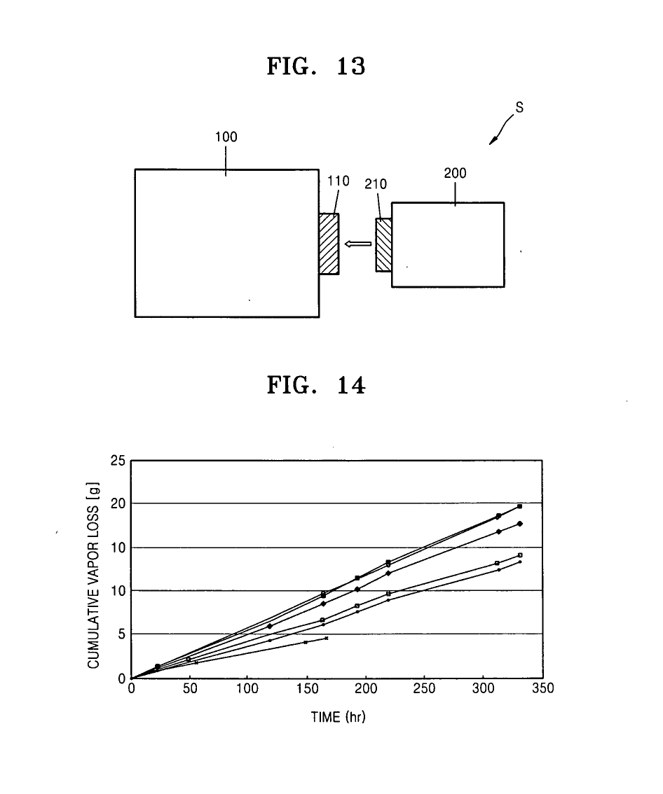

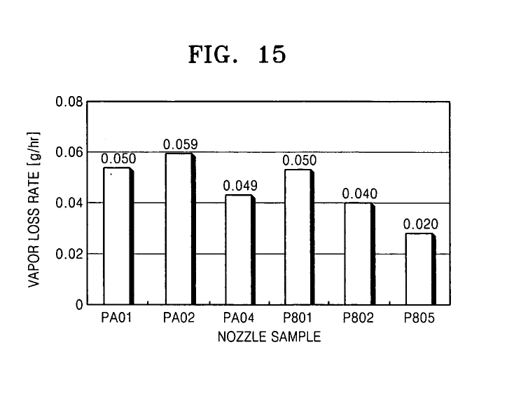

FIG. 14 is a graph showing fuel loss in a connector for a fuel cell due to evaporation over time according to an embodiment of the present invention. Referring to FIG. 14, measurement results of six sample fuel connectors are shown. The six sample fuel connectors are identical and have the same configuration as a fuel connector according to the embodiment of the present invention.

Referring to FIG. 14, inclinations of the graphs do not vary greatly. Thus, it can be seen from FIG. 14 that a fuel evaporation ratio of each of the samples over time is uniform.

FIG. 15 is a bar graph showing fuel loss in a connector for a fuel cell due to evaporation over time according to an embodiment of the present invention. The bar graph of FIG. 15 is with respect to the six sample fuel connectors used to obtain the results of FIG. 14.

Referring to FIG. 15, fuel loss in the sample fuel connectors due to evaporation over time are all less than 0.08 g/hr.

As can be seen from FIGS. 14 and 15, fuel loss due to evaporation over time in the fuel connectors according to the embodiments of the present invention is uniform, and a fuel loss due to evaporation over time is less than 0.08 g, and thus the fuel connectors comply with the international standard.

It should be understood that the exemplary embodiments described therein should be considered in a descriptive sense only and not for purposes of limitation. Descriptions of features or aspects within each embodiment should typically be considered as available for other similar features or aspects in other embodiments.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A fuel cell system connector, comprising:
an external structure configured to accommodate a connector of a fuel cartridge; and
an internal structure mounted in the external structure,
wherein a contact surface between the external structure and the internal structure includes a nano-processed surface on a fuel supply path.

2. The fuel cell system connector as claimed in claim 1, wherein the internal structure includes:
a hanger that overlaps the external structure; and
an elastic structure disposed in a vertical direction from the hanger, the elastic structure being configured to provide a seal when the fuel cell system connector is disconnected from the fuel cartridge, and being configured to form a supply path when the fuel cell system connector is coupled to the fuel cartridge.

3. The fuel cell system connector as claimed in claim 2, wherein the elastic structure includes:
a rod that is disposed in the vertical direction from the hanger and that is divided into at least two portions, a pin being formed at an end of an outer-most portion of the at least two portions of the rod;
an elastic ring that is connected to the at least two portions of the rod; and
an elastic body that surrounds portions of the rod inside the elastic ring.

4. The fuel cell system connector as claimed in claim 1, wherein the external structure includes:
a first protrusion that surrounds a fuel inlet through which fuel supplied from the fuel cartridge flows and that is configured to accommodate a fuel outlet of the fuel cartridge, an inner surface of the first protrusion having a nano-processed portion; and
a second protrusion that is configured to accommodate a circumferential portion of the fuel outlet in the connector of the fuel cartridge and that surrounds the first protrusion.

5. The fuel cell system connector as claimed in claim 4, wherein a selection key is formed on an outer surface of the first protrusion, and a retention key is formed on an inner surface of the second protrusion.

6. The fuel cell system connector as claimed in claim 4, wherein the fuel inlet is a cross-shaped hole.

7. The fuel cell system connector as claimed in claim 4, wherein a selection key is formed on an outer surface of the first protrusion, and the fuel cell system includes a space formed on an inner surface of the second protrusion for accommodating a retention key.

8. A fuel cartridge connector, comprising:
an external structure including a retention key; and
an internal structure mounted in the external structure,
wherein a contacting surface between the external structure and the internal structure includes a nano-processed surface on a fuel supply path.

9. The fuel cartridge connector as claimed in claim 8, wherein the internal structure includes:
a hanger overlapping the external structure; and
an elastic structure that is formed in a vertical direction from the hanger, the elastic structure being configured to provide a seal when the fuel cartridge connector is disconnected from an object to be supplied with fuel, and being configured to form a supply path when the fuel cartridge connector is coupled to the object to be supplied with fuel.

10. The fuel cartridge connector as claimed in claim 9, wherein the elastic structure includes:
a rod that is disposed in a vertical direction from the hanger, the rod being divided into at least two portions;
an elastic ring that connects ends of the at least two portions of the rod; and
an elastic body that surrounds portions of the rod inside the elastic ring.

11. The fuel cartridge connector as claimed in claim 8, wherein the external structure includes:
a first protrusion that comprises a fuel outlet and is configured to accommodate a connector of the object to be supplied with fuel, and an outer circumferential surface of the first protrusion includes a nano-processed portion; and
a second protrusion that surrounds a circumference of the first protrusion and includes a groove and the retention key, the retention key being configured to accommodate a selection key coupled to the object to be supplied with fuel.

12. The fuel cartridge connector as claimed in claim 11, wherein the fuel outlet is disposed at a peak of the first protrusion and is a cross-shaped hole.

13. A fuel cell system, comprising:
a fuel cartridge, the fuel cartridge including a second connector; and
a main body configured to be coupled to the fuel cartridge, the main body including a first connector coupled to the second connector, wherein:
the first connector includes a first external structure configured to accommodate the second connector of the fuel cartridge and a first internal structure mounted in the first external structure, a contact surface between the first external structure and the first internal structure including a first nano-processed surface on a fuel supply path; and
the second connector includes a second external structure having a retention key and a second internal structure mounted in the second external structure, a contacting surface between the second external structure and the second internal structure including a second nano-processed surface on the fuel supply path.

14. The fuel cell system as claimed in claim 13, wherein a fuel inlet of the first connector and a fuel outlet of the second connector are cross-shaped holes.

15. The fuel cell system as claimed in claim 13, wherein an inner surface around a circumference of the fuel inlet of the first connector and an outer circumferential surface of the second connector contacting the inter surface have nano-processed portions.

16. The fuel cell system as claimed in claim 13, wherein one of the first and second connectors comprises a selection key, and the other comprises a space for accommodating the selection key.

17. The fuel cell system as claimed in claim 16, wherein the selection key includes two fixing keys and one auxiliary key.
